(19) United States
(12) Patent Application Publication
(10) Pub. No.: US 2012/0255965 A1
(43) Pub. Date: Oct. 11, 2012

(54) STORAGE CONTAINER

(76) Inventor: Philip A. King, Sugar Hill, GA (US)

(21) Appl. No.: 13/441,971

(22) Filed: Apr. 9, 2012

Related U.S. Application Data
(60) Provisional application No. 61/472,932, filed on Apr. 7, 2011.

(51) Int. Cl. B65D 43/16; B23P 11/00

(52) U.S. Cl. 220/826; 220/836; 29/428

(57) ABSTRACT

A container according to one embodiment includes a plurality of walls extending upward from a base. A lid is hingeably attachable to a first wall of the plurality of walls by a hinge formed by a hinge pin on one of the lid and the first wall and a hinge receiver formed by the other of the lid and the first wall. The lid and the first wall each include a lever point against which a tool can be leveraged to assist in attaching the hinge pin into the hinge receiver.

This application claims priority to U.S. Provisional Application Ser. No. 61/472,932, filed Apr. 7, 2011.

### BACKGROUND

Attached-lid containers (ALCs) typically include a plurality of walls extending upward from a base. A pair of lids are hingeably connected to the upper edges of opposite side walls. Hinge pins and hinge receivers are formed on the lip of the container and at outer edges of the lids. The hinge pins can be difficult to snap fit into the hinge receivers.

### SUMMARY

A container according to one embodiment includes a plurality of walls extending upward from a base. A lid is hingeably attachable to one of the plurality of walls by a hinge. The hinge includes a hinge pin on one of the lid and one of the plurality of walls and a hinge receiver formed by the other of the lid and the one of the plurality of walls. The lid and the one of the walls each include a lever point against which a tool can be leveraged to assist in attaching the hinge pin into the hinge receiver.

In the disclosed embodiment, the lever points are holes. By inserting the tool into both holes, the tool can be used to leverage the hinge pin into the hinge receiver.

In the disclose embodiment, the container includes a lip protruding outward and downward from an uppermost edge of the one of the side walls, and the lever point is formed in the lip.

The lid may include a plurality of hinge members having recesses therebetween. The hinge pin may be formed integrally with the lid and project inward from the hinge member into the recess. The lever point on the lid may be formed on the hinge member.

### BRIEF DESCRIPTION OF THE DRAWINGS

FIG. 1 is a perspective view of a container according to one embodiment of the present invention, with one of the lids in an open position.

FIG. 2 is an enlarged view of one of the corners of the open lid of FIG. 1 adjacent the container, prior to attachment of the lid.

FIG. 3 is a section view through the lid and container of FIG. 2.

FIG. 4 shows the lid and container of FIG. 3, with a tool leveraging the lid into attachment to the container.

### DETAILED DESCRIPTION OF THE PREFERRED EMBODIMENT

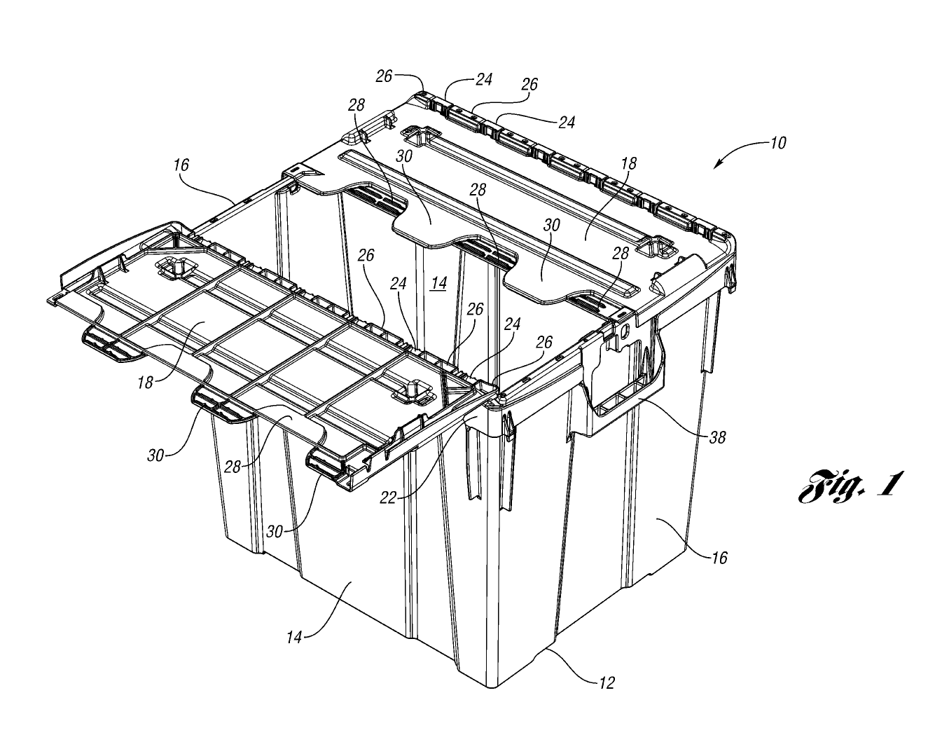

A storage container 10 according to one embodiment of the present invention is illustrated in FIGS. 1-4. Referring to FIG. 1, the storage container 10 includes a base 12 and a pair of opposed side walls 14 and a pair of opposed end walls 16 extending upwardly from the periphery of the base 12. Lids 18 are hingeably connected to upper edges of the side walls 14. A flange or lip 22 protrudes outward from the upper edge of the side walls 14 and the end walls 16. Over the side walls 14, the lip 22 includes a plurality of hinge receivers 24 formed thereon. The hinge receivers 24 hingeably retain hinge members 26 formed integrally with the lids 18.

The inner edge of each lid 18 includes a plurality of interlocking lower leaves 28 and upper leaves 30. The lids 18 can be pivoted away from one another to provide access to the storage container 10. Each end wall 16 includes a handle 38.

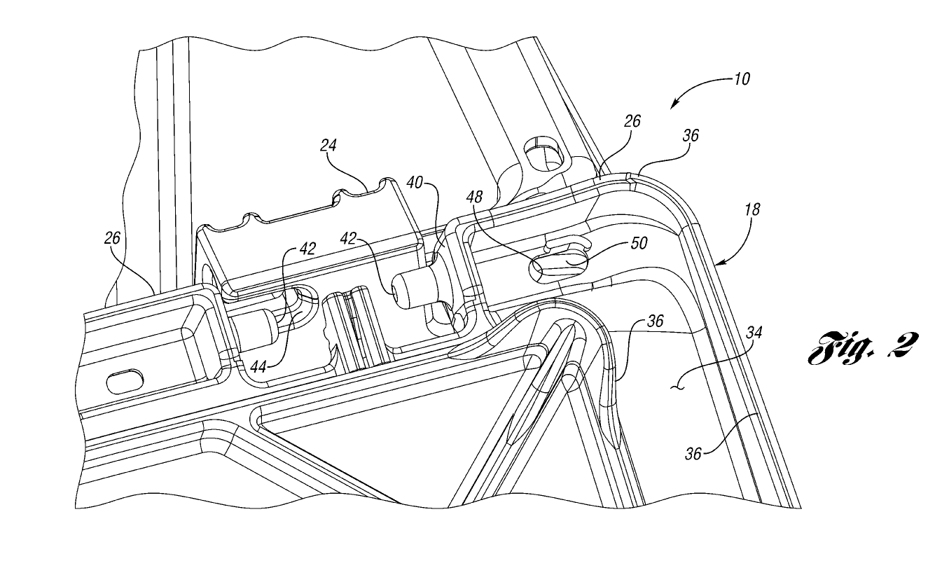

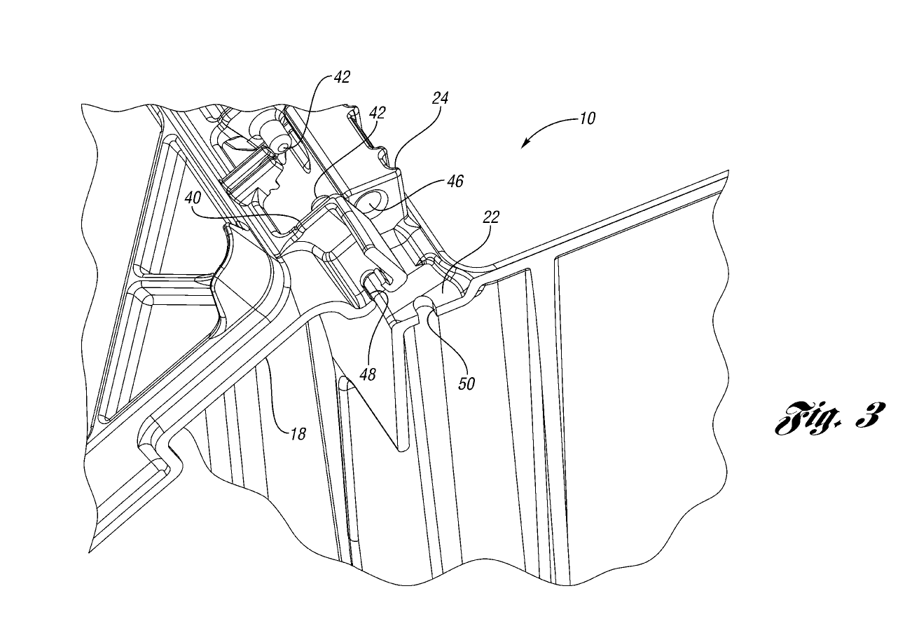

FIGS. 2-4 illustrate the attachment of one of the lids 18 to the side walls 16. Referring to FIG. 2, the lid 18 includes a panel portion 34 from which a plurality of ribs 36 project downward. The outer edge of the lid 18 includes a plurality of recesses 40 between the hinge members 26. The recesses 40 receive the hinge receivers 24. Hinge pins 42 project from the hinge members 26 toward one another in the recesses 40. The hinge receivers 24 include recesses 44 that open outwardly to receive hinge pins 42 therein. At each end of the container 10, the hinge receivers 24 include an aperture 46 (FIG. 3) that opens toward the end of the container 10. As can be seen in FIG. 2, the hinge pin 42 is not initially aligned with the aperture 46. Therefore, in one implementation according to the present invention, the hinge member 26 and the lip 22 are each provided with a lever point to assist in assembly. In this example, the hinge member 26 is provided with a hole 48 that is partially aligned (or nearly aligned) with a hole 50 through the lip 22 (FIGS. 2 and 3).

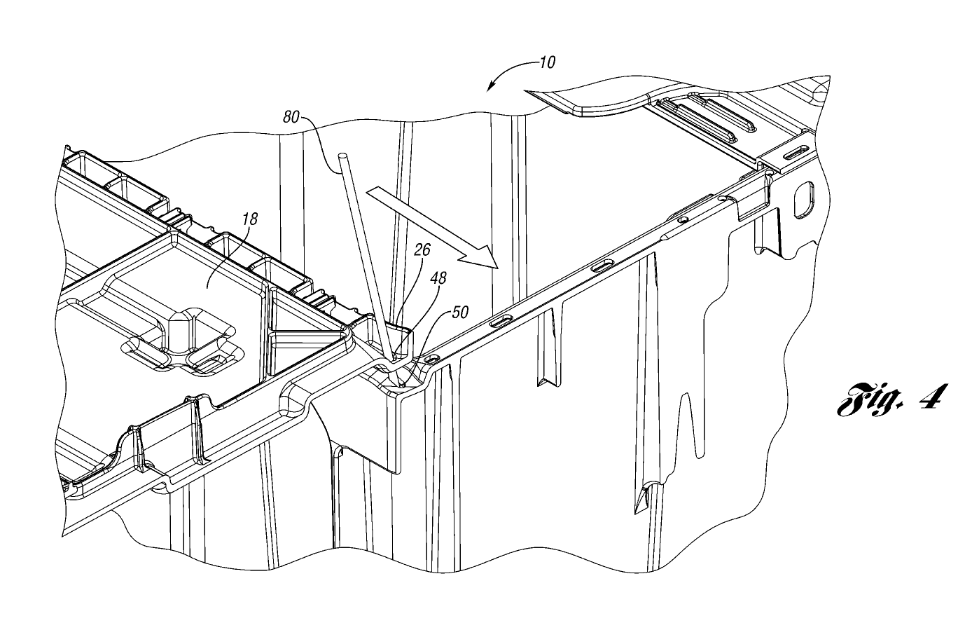

To assemble the lid 18 to the side walls 14 of the container 10, the opposite hinge pin 42 is first inserted into the hole 50 at the opposite end of the lid 18. Then, as shown in FIG. 4, an elongated tool 80 (e.g. screwdriver) is inserted at an angle through the holes 48, 50. By moving the tool 80 toward the end of the container 10 as shown in FIG. 4, the hinge member 26 is deflected outwardly until the hinge pin 42 is aligned with the aperture 46 in the hinge receiver 24. When the tool 80 is released, the hinge pin 42 is pulled into the aperture 46 in the hinge receiver 24 to hingeably retain the lid 18 to the container 10.

The holes 48, 50 and tool 80 provide an improved, easier method for assembling the lids 18 to the side walls 14 of the container 10.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A container comprising:
a base;
a plurality of walls extending upward from the base, the plurality of walls including a first wall;
a lid hingeably attachable to the first wall by a hinge formed by a hinge pin on one of the lid and the first wall and a hinge receiver formed by the other of the lid and the first wall, wherein the lid and the first wall each include a lever point against which a tool can be leveraged to assist in attaching the hinge pin into the hinge receiver.

2. The container of claim 1 wherein at least one of the lever points is a hole.

3. The container of claim 2 wherein both lever points are holes.

4. The container of claim 1 wherein the container includes a lip protruding outward and downward from an uppermost edge of the first wall, wherein the lever point on the first wall is formed in the lip.

5. The container of claim 1 wherein the lid includes a plurality of hinge members having recesses therebetween, the hinge pin formed integrally with the lid, the hinge pin projecting inward from the hinge member into the recess.

6. The container of claim 5 wherein the lever point on the lid is formed on the hinge member.

7. The container of claim 6 wherein the container includes a lip protruding outward and downward from an uppermost edge of the first wall, wherein the lever point on the one of the walls is formed in the lip.

8. The container of claim 7 wherein the hinge receiver is a projection at an upper edge of the first wall, wherein the hinge receiver includes an aperture for receiving the hinge pin of the lid, wherein the lever point on the first wall is formed on the lip.

9. The container of claim 8 wherein at least one of the lever points is a hole.

10. The container of claim 9 wherein the plurality of walls further includes a second wall opposite the first wall, the lid is a first lid, the container further including a second lid hingeably connected to the second wall, the first lid including a plurality of lower leaves and upper leaves on an inner edge thereof interlockable with a plurality of lower leaves and upper leaves on an inner edge of the second lid.

11. A method for assembling a lid to a container including the steps of:
a) placing a lid adjacent an upper edge of a first wall of a plurality of walls extending upward from a base;
b) during said step a), placing a hinge pin adjacent a hinge receiver;
c) after said step b), placing an elongated tool against a first lever point on the first wall and a second lever point on the lid; and
d) engaging the tool against the first lever point and the second lever point to assist in inserting the hinge pin into the hinge receiver.

12. The method of claim 11 wherein the first lever point is a first hole.

13. The method of claim 12 wherein the second lever point is a second hole.

14. The method of claim 13 wherein the container includes a lip protruding outward and downward from an uppermost edge of the one of the side walls, wherein the first hole is formed in the lip.

15. The method of claim 14 wherein the hinge receiver is a projection at an upper edge of the one of the plurality of walls, wherein the hinge receiver includes an aperture for receiving the hinge pin of the lid.
